(19) United States
(12) Patent Application Publication
(10) Pub. No.: US 2010/0295462 A1
(43) Pub. Date: Nov. 25, 2010

(54) ELECTRONIC BALLAST AND METHOD FOR CONTROLLING AT LEAST ONE LIGHT SOURCE

(75) Inventor: Martin Brueckel, Shenzhen (CN)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/864,253

(22) PCT Filed: Jan. 24, 2008
(86) PCT No.: PCT/EP08/50812

§ 371 Date: Jul. 23, 2010

(51) Int. Cl. H05B 41/36

(52) U.S. Cl. 315/246

(57) ABSTRACT

An electronic ballast for driving at least one light source may include an input for connecting a supply voltage; an output configured to connect the at least one light source; an oscillator, which is designed to provide an oscillator output signal with a first frequency at its output, the oscillator having a calibration input in order to alter the first frequency; and a microcontroller configured to provide a drive signal with at least one spectral component at a second frequency for the at least one light source, the microcontroller being coupled to the oscillator output and being designed to generate the second frequency as a function of the first frequency; wherein the electronic ballast furthermore includes a drive circuit, which is coupled to the calibration input, the drive circuit being designed to vary the first frequency during running operation of the electronic ballast via the calibration input.

### TECHNICAL FIELD

The present invention relates to an electronic ballast for driving at least one light source, the electronic ballast having an input for connecting a supply voltage, an output for connecting the at least one light source, an oscillator, which is designed to provide an oscillator output signal with a first frequency f_{OSC} at its output, the oscillator having a calibration input in order to alter the first frequency f_{OSC}, and a microcontroller for providing a drive signal with at least one spectral component at a second frequency f_{signal} for the at least one light source, the microcontroller being coupled to the oscillator output and being designed to generate the second frequency f_{signal} as a function of the first frequency f_{OSC}. Moreover, the invention relates to a method for driving at least one light source by means of a corresponding electronic ballast.

### PRIOR ART

The present invention relates in particular to the problem of generating a periodic signal, for example a PWM (=pulse width modulation) signal with a frequency f_{signal} which is as high as possible and a frequency resolution which is as high as possible by means of a microcontroller using a frequency f_{OSC} which is as low as possible for an oscillator, which is coupled to the microcontroller.

In the field of lighting engineering, this problem occurs, for example, when starting a discharge lamp. That is to say that a high voltage which is generated by resonance is required for starting the discharge lamp. In the case of a conventional and inexpensive method, the resonant frequency or a harmonic of the resonant frequency of a resonant circuit is excited for this purpose. In order to blank all of the tolerances of the resonant circuit, the frequency is varied, i.e. swept. In order to meet the maximum which is subject to tolerances with a maximum error which is as low as possible, the resolution of the frequency increments needs to be correspondingly high. In another application, the switching frequency of the lamp current is varied in order to avoid resonant effects in the lamp. In another application, the switching frequency in an electronic circuit is varied in order to make the electric magnetic interference emission more broadband than in the case of a fixed switching frequency.

Time-dependent periodic signals are often generated by means of a microcontroller. In the process, the microcontroller is often clocked by an oscillator at a fixed frequency f_{OSC}. By virtue of internal meters, for example so-called PWM units, periodic signals with a frequency f_{signal} which can be set or an on and off time which can be set can be generated therefrom and emitted by the microcontroller. In the prior art, the higher the frequency f_{signal} of a signal to be generated at a fixed available oscillator frequency f_{OSC}, the lower the relative frequency resolution of the periodic signal to be generated will be.

One example will be used to explain this: the oscillator frequency f_{OSC} is 10 MHz, i.e. one period of oscillation is 100 ns. In the case of a signal to be generated with the frequency f_{signal}=10 kHz, a period of oscillation comprises 100 μs. Therefore, a period of oscillation comprises 1000 ticks of the clock of the oscillator frequency. The relative frequency resolution is thus 1/1000=0.1%. If, however, a signal with a frequency f_{signal} of 1 MHz is to be generated, the period of oscillation is 1 μs and therefore now only 10 ticks of the clock predetermined by the oscillator frequency f_{OSC}. The relative frequency resolution is therefore reduced to 1/10=10%. In the prior art, therefore, the relative resolution is proportional to the ratio of f_{OSC}/f_{signal}. The lower this ratio is, the lower the relative frequency resolution is in the signal to be generated.

In the prior art, therefore, an oscillator with a frequency f_{OSC} is selected, whose resolution 1/f_{OSC} is sufficiently fine for the required resolution for the signal with the frequency f_{signal} to be generated. If, for example, a signal with f_{signal} equal to 100 kHz and a resolution of 1%, i.e. the frequency can be set in 1% increments, is made available, an oscillator with an oscillator frequency of 100 kHz/1%=10 MHz is selected in the prior art.

The oscillator which is already provided as standard in a microcontroller with the frequency f_{OSC} is often used in order to generate a signal with the frequency f_{signal} by the microcontroller. Correspondingly, the selection of the microcontroller is often geared to the integrated oscillator. In order to provide signals with a high frequency f_{signal} at the output of the microcontroller and, in addition to this, with a high resolution, it is therefore often necessary to deviate in favor of well equipped and therefore expensive microcontrollers.

It is known from the prior art to set the frequency f_{OSC} of the signal which is made available by an oscillator via the calibration input of the oscillator. This is carried out once, before an electronic ballast provided therewith is first used and is used for the purpose of ensuring that different electronic ballasts provide comparable signals for the light sources to be connected thereto at the output of said ballasts.

DE 43 01 184 A1 has disclosed a control device for at least one discharge lamp, which control device has an inverter which is connected to a DC voltage source for changing, at a low frequency, the direction of current flow through the discharge lamp and a power controller, which is connected to a current sensor. The oscillator for the high frequency can be altered in terms of its high frequency by a control signal during operation, with it being possible, as a result, for the current flowing through an inductance and the discharge lamp to be switched on and off and to be kept constant by virtue of regulation of the pulse width of the resultant current. By virtue of the alteration of the high frequency of the oscillator, it is possible in this way to avoid instabilities which occur as a result of resonance phenomena. The oscillator is a conventional VCO (Voltage Controlled Oscillator), in which the frequency output thereby can be altered by varying the voltage applied to its control input. In addition to the control input, a VCO has a calibration input, with which the dependency between the applied voltage and the output frequency can be set. The problems mentioned at the outset result with such a control device.

The present invention is therefore based on the object of developing an electronic ballast mentioned at the outset or a method mentioned at the outset such that a signal with a frequency f_{signal} which is as high as possible and/or a frequency resolution which is as high as possible can be generated using a given oscillator with an oscillator frequency f_{OSC} by the microcontroller coupled thereto.

This object is achieved by an electronic ballast having the features of patent claim 1 and by a method having the features of patent claim 11.

The present invention is based on the knowledge that, in order to achieve the above-defined object, the calibration input of the oscillator can be used in optimum fashion if said calibration input is correspondingly driven during running operation of the electronic ballast. According to the invention, the electronic ballast therefore furthermore has a drive circuit, which is coupled to the calibration input, the drive circuit being designed to vary the first frequency f_{OSC} during running operation of the electronic ballast via the calibration input.

The frequency f_{signal} of the periodic signal generated by the microcontroller is therefore set, altered or adjusted finely during running operation by changing, i.e. recalibrating, the frequency f_{OSC} of the oscillator during running operation. The resolution which can be achieved thereby when setting the frequency f_{signal} of periodic signals is in particular independent of the ratio of the frequency f_{OSC} of the oscillator to the frequency f_{signal} of the signal to be generated by the microcontroller. It is now only dependent on the resolution with which the frequency f_{OSC} of the oscillator itself can be altered.

If, for example, a signal with a frequency f_{signal}=100 kHz and a resolution of 1% is intended to be generated, as in the example above, in the extreme case an oscillator with a frequency f_{OSC} of 100 kHz can be selected if the oscillator can be calibrated in 1% increments during running operation. This results in significantly lower demands being placed on the frequency f_{OSC} of the oscillator than in the prior art.

By using an oscillator for making available a low frequency f_{OSC}, cost savings can be made when implementing the same result as in the prior art. In particular, it is possible to use a microcontroller with reduced capabilities for generating time-dependent signals since, for example, no internal PLL (Phase Locked Loop) is required for generating a high intermediate frequency and the resolution of internal timer functions can be lower. A cost saving of from 20 to 40% can thus be realized with the microcontroller. In particular, the present invention makes it possible to use the internal RC oscillator of a micro-controller for many applications instead of an external oscillator, which may be required in the prior art, in order to provide higher oscillator frequencies f_{OSC} than those which are possible with the internal RC oscillator.

Nevertheless, the present invention can be implemented with the internal oscillator of a microcontroller or with an external oscillator of a microcontroller.

Moreover, the present invention makes it possible to reduce the current consumption of the oscillator since this current consumption generally increases with the frequency f_{OSC}.

The tolerance of the frequency of an oscillator which can be calibrated is generally higher than that of an oscillator, i.e. quartz or resonator, with a fixed frequency. Therefore, the present invention can be used particularly advantageously when the precise absolute value of a set frequency f_{signal} can have the corresponding frequency, but it is necessary to ensure that a specific frequency range with a specific resolution is covered by a time-dependent signal to be generated (as is the case in the exemplary embodiments mentioned at the outset).

In accordance with a first preferred embodiment, the oscillator is coupled to the microcontroller in such a way that it clocks the microcontroller. Alternatively, it can be provided that the microcontroller comprises a timer apparatus, in particular a pulse width modulation apparatus, which is designed to provide the drive signal, the oscillator being coupled to the microcontroller in such a way that it clocks the timer apparatus. In this case, for example, the output compare value or the prescaler value of the timer apparatus can be changed.

Preferably, the electronic ballast includes a calibration register, which is coupled to the oscillator. It is further preferred in this case if a predeterminable value can be set in the calibration register, the calibration register being designed for a change in the predeterminable value during running operation of the electronic ballast. As a result, the frequency f_{OSC} and therefore the frequency f_{signal} can be changed in a particularly simple manner.

Preferably, the predeterminable value can be changed in increments of 0.5% to 10%. A frequency resolution which is sufficiently fine in most applications can therefore be achieved.

In order to produce a start value again, if required, the calibration register can be designed to store at least one predeterminable value. As an alternative or in addition, it can also be provided that the value of the calibration register is stored, in which a resonance has been fixed, for example in order to avoid said resonance (acoustic resonance) or to set said resonance (starting resonance).

Preferably, the ratio of f_{signal} to f_{OSC} is between 1:1 and 100:1.

In accordance with a first preferred embodiment, the oscillator is provided in the microcontroller, as has already been mentioned. In accordance with a second preferred embodiment, however, the oscillator can also be provided outside the microcontroller.

Further preferred embodiments are given in the dependent claims.

The preferred embodiments proposed with reference to the electronic ballast according to the invention and the advantages thereof apply correspondingly, if appropriate, to the method according to the invention.

### BRIEF DESCRIPTION OF THE DRAWING(S)

An exemplary embodiment of an electronic ballast according to the invention will now be described in more detail below with reference to the attached drawing, which shows a schematic illustration of an exemplary embodiment of an electronic ballast according to the invention.

### PREFERRED EMBODIMENT OF THE INVENTION

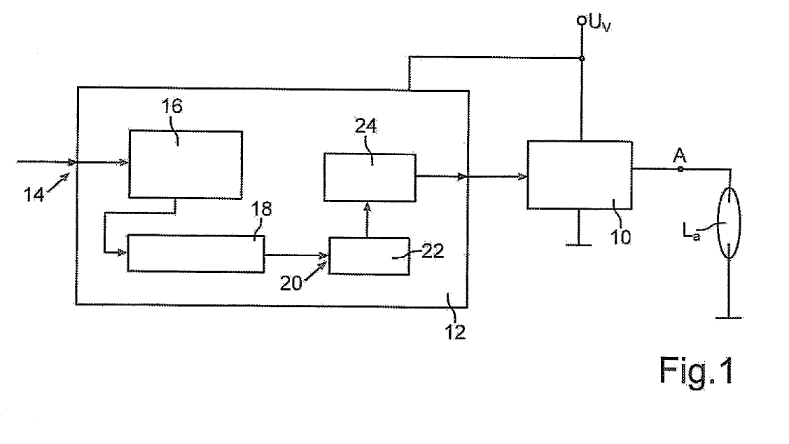

FIG. 1 shows a schematic illustration of the design of an electronic ballast according to the invention. Said electronic ballast includes a block 10, in which the elements which are less at the foreground in terms of the present invention and have long been known to a person skilled in the art are combined. These elements are, for example, elements for radio interference suppression, for rectification, for power factor correction, a bridge circuit, coupling and resonant capacitors, a lamp inductor or the like. A light source La, in this case a discharge lamp, is connected to the output A of the block 10. The invention can easily be transferred to other types of light sources. The electronic ballast illustrated in FIG. 1 includes a supply voltage terminal Uᵥ, which is coupled firstly to the block 10 and secondly to a microcontroller 12. The microcontroller 12 includes an interface 14, via which access to a drive circuit 16 is made possible. The drive circuit 16 is coupled to a calibration register 18 and is designed to vary the entry in calibration register 18 during running operation of the electronic ballast. The calibration register 18 is coupled to the calibration input 20 of an oscillator 22, which provides a signal with a frequency f_{OSC} to a timer apparatus 24 as a function of the signal applied to its input 20. The timer apparatus can in particular represent a pulse width modulation apparatus.

The timer apparatus 24 provides a drive signal with at least one spectral component at the frequency f_{signal} for the at least one light source at its output, which is coupled to the output of the microcontroller 12, the timer apparatus generating the frequency f_{signal} as a function of the frequency f_{OSC}, which has long been known to a person skilled in the art.

While the oscillator 22 is part of the microcontroller 12 in the exemplary embodiment illustrated, the oscillator 22 can also be arranged outside the microcontroller 12 in order to drive the microcontroller 12. While the oscillator 22 clocks the timer apparatus 24 in the exemplary embodiment illustrated, provision can also be made for the oscillator 22 to clock the microcontroller 12 itself, for example via a clock input of the microcontroller 12.

It is therefore possible, using the drive circuit 16, which is coupled to the calibration input 20 of the oscillator 22 via the calibration register 18, to alter the frequency f_{signal} of the signal provided at the output of the microcontroller 12 during running operation of the electronic ballast via the interface 14. The provided signal at the output of the microcontroller 12 can be used, for example, to drive the switches in a half-bridge circuit, whose half-bridge center point is coupled to the output A in order to drive the lamp La.

In addition to the advantages already mentioned above, the invention can also be used when setting a sequence of light changes with a high temporal resolution, for example via a color wheel in projection lamps. It is likewise possible in the case of LED projection or in the case of LED backlighting for the different light levels to be controlled with a high degree of temporal resolution and using an extremely inexpensive microcontroller.

The microcontroller illustrated in FIG. 1 may be an ATMEL microcontroller of the AVR family, for example. This includes an RC oscillator, with it being possible for individual capacitors and nonreactive resistors of the oscillator to be connected or disconnected via a calibration register 18. According to the invention, this is brought about during running operation via the calibration input 20 of the oscillator 22.

1. An electronic ballast for driving at least one light source, the electronic ballast comprising:
an input for connecting a supply voltage;
an output configured to connect the at least one light source;
an oscillator, which is designed to provide an oscillator output signal with a first frequency at its output, the oscillator having a calibration input in order to alter the first frequency; and
a microcontroller configured to provide a drive signal with at least one spectral component at a second frequency for the at least one light source, the microcontroller being coupled to the oscillator output and being designed to generate the second frequency as a function of the first frequency;
wherein characterized in that the electronic ballast furthermore comprises a drive circuit, which is coupled to the calibration input, the drive circuit being designed to vary the first frequency during running operation of the electronic ballast via the calibration input.

2. The electronic ballast as claimed in claim 1,
wherein the oscillator is coupled to the microcontroller in such a way that it clocks the microcontroller.

3. The electronic ballast as claimed in claim 1,
wherein the microcontroller comprises a timer apparatus, in particular a pulse width modulation apparatus, which is designed to provide the drive signal, the oscillator being coupled to the microcontroller in such a way that it clocks the timer apparatus.

4. The electronic ballast as claimed in claim 1,
wherein the electronic ballast comprises a calibration register, which is coupled to the oscillator.

5. The electronic ballast as claimed in claim 4,
wherein a predeterminable value can be set in the calibration register, the calibration register being designed for a change in the predeterminable value during running operation of the electronic ballast.

6. The electronic ballast as claimed in claim 5,
wherein the predeterminable value can be changed in increments of 0.5% to 10%.

7. The electronic ballast as claimed in claim 4,
wherein the calibration register is designed to store at least one predeterminable value.

8. The electronic ballast as claimed in claim 1,
wherein the ratio of f_{signal}/f_{OSC} is between 1:1 and 100:1.

9. The electronic ballast as claimed in claim 1,
wherein the oscillator is provided in the microcontroller.

10. The electronic ballast as claimed in claim 1,
wherein the oscillator is provided outside the microcontroller.

11. A method for driving at least one light source by means of an electronic ballast with an input for connecting a supply voltage; an output configured to connect the at least one light source; an oscillator, which is designed to provide an oscillator output signal with a first frequency at its output, the oscillator having a calibration input in order to alter the first frequency; and a microcontroller configured to provide a drive signal with at least one spectral component at a second frequency for the at least one light source, the microcontroller being coupled to the oscillator output and being designed to generate the second frequency as a function of the first frequency;
the method comprising:
varying the first frequency during running operation of the electronic ballast by means of a drive circuit, which is coupled to the calibration input.

12. The electronic ballast as claimed in claim 3,
wherein the timer apparatus is a pulse width modulation apparatus.
